(19) United States
(12) Patent Application Publication
(10) Pub. No.: US 2010/0192744 A1
(43) Pub. Date: Aug. 5, 2010

(54) A Paper Cutter with Changeable Cutter Holder

(76) Inventor: Ning Xu, GuangDong (CN)

Correspondence Address: Jackson Intellectual Property Group PLLC, 106 Starvale Lane, Shipman, VA, 22971, US

(21) Appl. No.: 12/159,542

(22) PCT Filed: Jan. 25, 2006
(86) PCT No.: PCT/CN06/00148

§ 371 Date: Mar. 25, 2010

(30) Foreign Application Priority Data
Dec. 28, 2005 (CN) 200520121120.3

(51) Int. Cl. B26D 7/26

(52) U.S. Cl. 83/481

(57) ABSTRACT

A paper cutter with changeable cutter holder includes a slideway support, a slideway, a worktable support, a cover, a control block, and a changeable cutter holder. The slideway is placed under the slide-way support. The worktable support providing with the changeable cutter holder is placed on the slideway, and the control block is placed on the cover provided on the workable support. The present invention ensures it couldn't happen to hurt user's hand during changing cutter, so it is safety and reliable, and convenient for changing cutter.

### BACKGROUND OF THE INVENTION

(a) Field of the Invention

The present invention relates to a paper cutter, and more particularly to a paper cutter with a safety changeable cutter holder.

(b) Description of the Related Art

Traditionally, a blade of a paper cutter is changed manually, but this way of changing a blade bears a risk of cutting a user's hand during the process of changing the blade, and thus another way of changing blades by a magnetic attraction was introduced and adopted, but the operation of the magnetic attraction method is inconvenient and the safety issue still exists. Furthermore, both of the aforementioned methods have the drawback of losing the blade easily.

### SUMMARY OF THE INVENTION

It is a primary objective of the present invention to overcome the shortcomings of the prior art by providing a paper cutter with a safety changeable cutter holder.

To achieve the foregoing objective, the present invention provides a paper cutter comprising a slideway support, a slideway, a workable support, a cover, a control block and a changeable cutter holder. The slideway is placed under the slideway support, and the workable support is placed on the slideway, and the cover is covered onto the workable support, and the control block is placed on the cover, and the changeable cutter holder is installed in the workable support.

The changeable cutter holder comprises an upper casing, a lower casing, a pillar, a spring, a blade, a clamp, an axle, a pressing hole and a blade exit. The axle is passed through a center hole of the blade and fixed by the clamp. The spring is passed through an upper end of the clamp and fixed onto the pillar. The pillar is disposed at the top of the lower casing. The pressing hole is disposed at the upper end of the lower casing. The blade exit is disposed at the lower end of the lower casing.

The blade is a vertical blade, a ripple blade, or chopping blade.

The pressing hole and the control block are aligned with each other, such that the cover can be pressed to insert the control block into the pressing hole to press the clamp downward for extending the blade out from the blade exit.

The blade includes a recess for fixing the clamp.

The changeable cutter holder comprises a cutter box, a blade and a spring, both contained in the cutter box. When the control block is pressed to push the clamp downward, the blade is extended out from the blade exit for a normal paper cutting operation. With the resilience of the spring, the blade is stored in the cutter box after the paper cutting operation is completed.

Compared with the prior art, the present invention adopted the aforementioned technical measures to prevent users' hands from being cut accidentally during the process of changing blades, so as to achieve a safe, reliable and convenient way of changing blades.

### BRIEF DESCRIPTION OF THE DRAWINGS

FIG. 1 is a perspective view of the present invention;

FIG. 2 is a schematic view of a structure of a changeable cutter holder in accordance with the present invention; and

FIG. 3 is an exploded view a structure of a changeable cutter holder in accordance with the present invention.

### DETAILED DESCRIPTION OF THE PREFERRED EMBODIMENTS

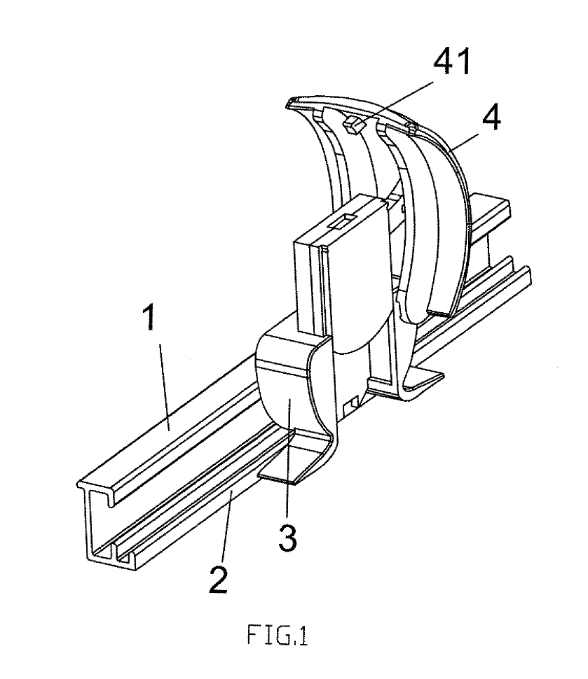

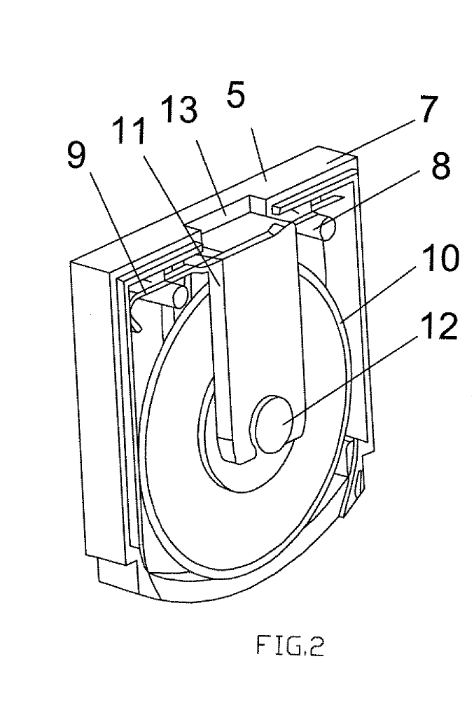

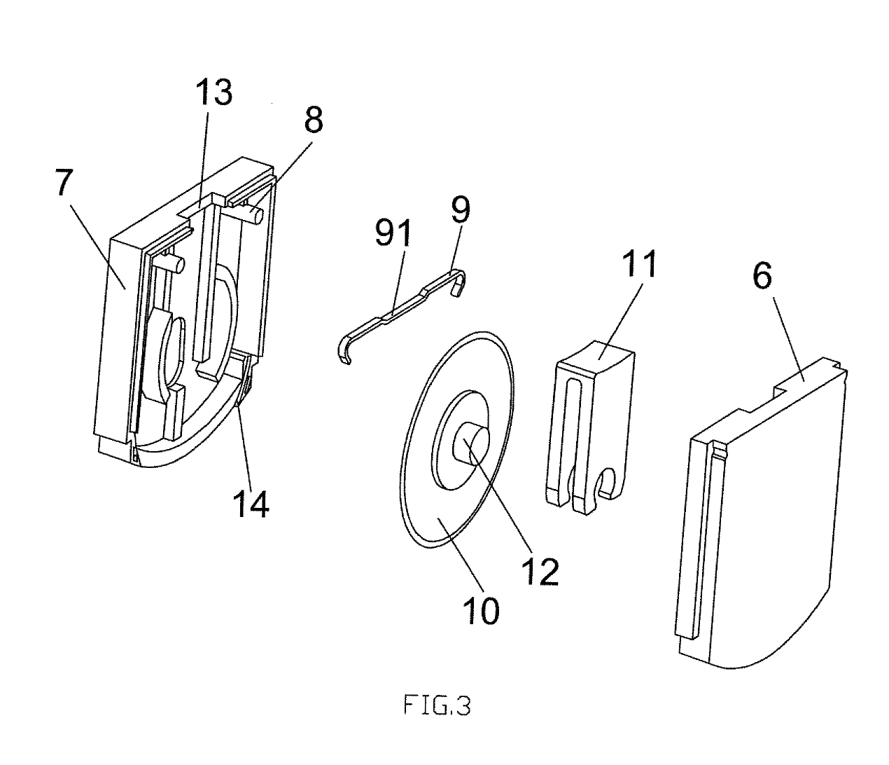

With reference to FIGS. 1 to 3 for a paper cutter of the invention, the paper cutter comprises a movable slideway support 1, a slideway 2, a workable support 3, a cover 4, a control block 41, and a changeable cutter holder 5. The workable support 3 is disposed on the slideway 2, and the cover 4 is covered onto the workable support 3, and the control block 41 is disposed on the cover 4, and the changeable cutter holder 5 is installed in the workable support 3.

The changeable cutter holder comprises an upper casing 6, a lower casing 7, a pillar 8, a spring 9, a blade 10, a clamp 11, an axle 12, a pressing hole 13, and a blade exit 14. The axle 12 is passed through a center hole of the blade 10 and fixed by the clamp 11. The spring 9 is passed through an upper end of the clamp 11 and fixed onto the pillar 8, The pillar 8 is disposed on the top of the lower casing 7, and the pressing hole 13 is disposed at an upper end of the lower casing 7, and the blade exit 14 is disposed at the lower end of the lower casing 7.

The blade is a vertical blade, a ripple blade or a chopping blade.

The control block 41 and the pressing hole 13 are aligned with each other, such that the cover 4 can be pressed to insert the control block 41 into the pressing hole 13 to press the clamp 11 downward for extending the blade 10 out from the blade exit 14.

The spring 9 includes a recess 91 for positioning the clamp 11

I claim:

1. A paper cutter, comprising a slideway support, a slideway, a workable support and a cover, characterized in that said paper cutter comprises a control block and a changeable cutter holder, and said changeable cutter holder comprises a blade box, a blade and a spring, both installed in said blade box, and said workable support is disposed on said slideway, and said cover is disposed on said workable support, and said control block is disposed on said to cover, and said changeable cutter holder is disposed in said workable support.

2. The paper cutter with changeable cutter holder of claim 1, wherein said changeable cutter holder comprises an upper casing and a lower casing of said blade box, a pillar, a spring, a blade, a clamp, an axle, a pressing hole, and a blade exit, and said axle is passed through a center hole of said blade and fixed by said clamp, and said spring is passed through an upper end of said clamp and fixed onto said pillar, and said pillar is disposed on the top of the lower casing, and said pressing hole is disposed at an upper end of said lower casing, and said blade exit is disposed at a lower end of said lower casing.

3. The paper cutter with changeable cutter holder of claim 1, wherein said blade is a vertical blade, a ripple blade or a chopping blade.

4. The paper cutter with changeable cutter holder of claim 1, wherein said control block corresponds to said pressing hole

5. The paper cutter with changeable cutter holder of claim 1, wherein said spring includes a recess disposed thereon.
